(19) United States
(12) Patent Application Publication
(10) Pub. No.: US 2023/0140219 A1
(43) Pub. Date: May 4, 2023

(54) ITEM LEVEL PICKING METHOD AND SYSTEM

(71) Applicants: Dematic Corp., Grand Rapids, MI (US); Dematic GmbH, Heusenstamm (DE)

(72) Inventors: Anthony W. Hasman, Howard City, MI (US); Stan R. Molesky, Asheville, NC (US); Shin Yamashita, Oberursel (DE); Jeffrey M. Jacobs, Wauwatosa, WI (US); William R. Boer, Wayland, MI (US)

(21) Appl. No.: 17/976,264

(22) Filed: Oct. 28, 2022

Related U.S. Application Data
(60) Provisional application No. 63/273,461, filed on Oct. 29, 2021.

(51) Int. Cl. B65G 1/137; G06Q 10/08; G06F 3/01; G02B 27/01

(52) U.S. Cl. CPC B65G 1/1371; B65G 1/1378; G06Q 10/087; G06F 3/011; G06F 3/016; G02B 27/017; B65G 2203/046; G02B 2027/0178

(57) ABSTRACT

An RFID enabled system and method for tracking, directing, verifying, and validating item level order picking functions within order fulfilment and warehouse facilities having different SKUs sharing an inventory tote. RFID tags are coupled to each inventory item to be read by one or more RFID reader(s) in the facility. The system and method verify that a required item is picked and transferred correctly by the picker. The system provides feedback to the picker without requiring additional verification steps and preferably without any visual inspection by the picker. The picker may be guided to the required item and later directed to a location to place the retrieved item. The verification system may be adapted for use in a material handling system to monitor and direct material handling functions based on relative positions of RFID tags on individual items relative to RFID readers positioned throughout the facility.

### CROSS REFERENCE TO RELATED APPLICATION

The present application claims priority of U.S. provisional application Ser. No. 63/273,461, filed Oct. 29, 2021, which is hereby incorporated by reference herein in its entirety.

### FIELD OF THE INVENTION

The present invention is directed to order-fulfilment and inventory management, and in particular to picking operations within an order-fulfilment facility.

### BACKGROUND OF THE INVENTION

Order pickers in order fulfilment facilities may not be able to quickly tell the difference between visually similar items that have different stock keeping units (SKUs), or may be confused, tired, or for some other reason unable to easily make distinctions between items presented to them in inventory totes. Some of these are true of both human and robotic order pickers. These common concerns can result in miss-picks or miss-places, which can lead to orders being incorrectly filled. In the event the operator visually identifies the correct item, the operator must then confirm the correct pick, such as by scanning the item with a scanner and/or pressing a physical confirmation button. Such confirmation steps take valuable time to complete. In instances where multiple different SKUs are present in an inventory tote, it is likely that wanted or required items are mixed in with unwanted or not currently required items, which creates the challenge to order picker of trying to discern which item is the wanted item. Additionally, items may be difficult to locate and access in totes with several items when there is no knowledge for the order picker of roughly where in the tote in three-dimensional space the item is likely to be, requiring order pickers to sort through unwanted items to locate the wanted item. It is common for multiple order containers to be present at one time within a workstation and operators may become confused or slowed by having to determine which is the correct container to place an order item into. Misplaced items may lead to miss-shipments and/or wasted time as items must be recovered and placed in the correct location.

Robotic picking operators and human operators may both be utilized in order fulfilment operations, with each having inherent advantages as well as inherent disadvantages. Robotic pickers, similar to human pickers, may have difficulties distinguishing between visually similar items, depending on the sophistication of their machine vision. In instances where inventory totes are loaded with multiple heterogeneous items/SKUs that are stacked on top of one another, robotic pickers must typically remove any unwanted items from the tote and set those items aside before continuing to retrieve the wanted item that was obstructed (e.g. beneath) the unwanted item. As such, the picking operations require additional time which decreases throughput and efficiency. Inventory totes are often filled below capacity to prevent overcrowding and obscuring items at the bottom or middle of the tote. Leaving additional capacity permits pickers to more quickly locate items when they are using visual inspection techniques. Underutilized capacity of inventory totes increase the footprint of the facility by requiring additional storage locations to store additional under-filled totes.

### SUMMARY OF THE INVENTION

The present invention provides a system and method for verification of item level order picking at a goods-to-person (GTP) or goods-to-robot (GTR) picking workstation utilizing radio frequency identification (RFID) based item identification of picked and/or placed items without an operator performing a secondary identification process (e.g. scanning a label of the item), as well as item and/or receptacle level tracking within a material handling system or facility.

According to one form of the present invention, a method is provided for monitoring, verifying, and/or validating item level order fulfilment operations within an order fulfilment or warehouse facility. The method includes transporting a receptacle or tote containing a plurality of different or heterogeneous inventory items to an order fulfilment workstation. At least some of the inventory items in the receptacle include an RFID tag. Preferably, all of the inventory items in the receptacle and in the entire facility include an RFID tag. The receptacles may also include an RFID tag. Each RFID tag includes an RFID identifier and each unique RFID identifier is assigned to a particular type of inventory item, such that identical items may have the same RFID identifier, but dissimilar items have different RFID identifiers. The method includes locating, within the receptacle, an item required for an order and, once located, an operator (human or robot) retrieves the required item from the receptacle. The method includes verifying that the operator has selected the required item by recognizing a movement of the RFID tag coupled to that item utilizing an RFID reader that is positioned at the workstation. The RFID reader is in communication with a computer of an order management system that controls and directs order fulfilment operations within the facility. The computer receives information from the RFID reader and determines, based on the received information, whether the RFID tag has moved relative to either of the workstation, the receptacle containing the inventory item, and/or the RFID tags of other items in the receptacle. The method may permit inventory totes to be filled to a higher percentage of their capacity, without the concern of slowing pickers down when they must retrieve an item from the significantly filled tote. Thus, the method may enable order fulfilment and warehouse facilities to be confined to smaller footprints, thus saving space and overhead costs.

In one aspect, recognizing a movement of the RFID includes recognizing a change in a positional characteristic of the RFID tag, such as an elevation change, a horizontal translation, or a rotation, for example. In another aspect, locating the required item within the receptacle includes detecting the RFID tag of the required item utilizing the radio frequency scanner and may include directing the operator to the required item within the receptacle with a visual/visible, audible, or physical cue such as with a laser light, a heads-up display, a spatial sonification device (e.g. a directional speaker), a wearable device with a haptic feedback function (e.g. a glove with vibratory or haptic feedback), a smart lighting system, and/or electronic feedback (for robotic operators), for example. Alternatively, the operator may manually locate the required item by reaching into the receptacle and making a physical or visual determination to select the item.

In still another aspect, once the correct item has been retrieved and verified, the method includes transferring the required item from the receptacle to an assigned order container and subsequently validating that the required item is disposed in the assigned order container by determining that the location of the item's RFID tag is within an envelope of the assigned order container. Optionally, validating that the required item is disposed in the assigned order container includes determining a location of an RFID tag coupled with the assigned order container and comparing the position of the required item's RFID tag relative to the envelope of the assigned order container. Preferably, the envelope dimensions of the assigned order container (relative to the container's RFID tag) are associated with its RFID tag. As such, the RFID reader and computer may determine the position of the assigned order container and its envelope dimensions. However, it will be appreciated that the envelope dimensions may be determined by other acceptable means, such as by capturing image data of the order container with an image capture device (e.g. camera or photoeye) and the computer determining the dimensions of the container with the capture image data, for example.

In another form of the present invention, a verification system is provided for monitoring item level order fulfilment operations at an order fulfilment workstation that is in communication with an order management system. The verification system includes a computer in communication with the order management system, a radio frequency identification (RFID) reader in communication with the computer. The RFID reader is operable to read an RFID tag coupled to an inventory item which is present at the workstation (within a sufficient proximity of the RFID reader) and to communicate the RFID identifier information associated from that RFID tag to the computer. The computer determines a location of the inventory item's RFID tag relative to either the workstation, a receptacle containing the inventory item, and/or RFID tags of other items present in the receptacle. The computer verifies that an operator at the workstation has chosen a particular, correct one of the plurality of inventory items that are present at the workstation by determining a movement of the RFID tag of the correct inventory item. In other words, if the operator selects and moves the correct item and the computer determines that that item's RFID tag has moved a significant amount, then it is determined that the operator has retrieved the correct item.

In one aspect, the computer system controls the order fulfilment workstation and directs item level picking operations of an operator at the order fulfilment workstation. In another aspect, the verification system includes a pick directing device for directing the operator to the location of a particular one of the inventory items at the workstation. Examples of pick directing devices include, but are not limited to, a laser light, a heads-up display, a spatial sonification device, and/or an operator worn haptic feedback device. In terms of robotic operators, the order management system, i.e. computer, controls the robot to accurately direct the robot picker to the required item.

In yet another aspect, the computer directs an operator to place the retrieved item in a particular order container (or onto a conveyor or into another inventory tote) and validates that the operator has placed the item in the correct order container by determining that the location of the item's RFID tag is within an envelope of the correct order container. Optionally, the order container may include an RFID tag with a unique RFID identifier and the RFID reader may read the container's RFID tag. Utilizing the RFID tag information of the container and inventory item, the computer directs the operator to place the item into the particular order container and to validate that the operator has placed the item in the correct order container by determining that the location of the item's RFID tag is within an envelope of the correct order container, such as by determining that the item's RFID tag is in close enough proximity to the container's RFID tag. Preferably, the envelope of the order container is associated with the container's RFID tag and that envelope information may be used by the computer to determine that the item is within the envelope of the container.

In another form of the present invention, an RFID enabled material handling system for item level material handling operations. The material handling system includes an order management system having a computer for controlling the various components of the material handling system. The material handling system includes an automated storage and retrieval system (ASRS), an automated sorter in transport communication with the ASRS, and several radio frequency identification (RFID) readers positioned proximate or spaced along various or multiple portions of the ASRS and/or the sorter. Each of the RFID readers is in communication with the computer and each is operable to read RFID tags affixed to individual inventory items (or containers or receptacles) as they pass along the material handling system. The individual inventory items must pass by an RFID reader within a sufficient proximity in order for the RFID reader to accurately read the item's RFID tag. The RFID readers communicate information associated with any read RFID tags to the computer and the computer may then determine a location of the read inventory item's RFID tag relative to the RFID reader that communicates the RFID tag information to the computer. Based on the determined locations of the RFID tags, and therefore the individual inventory items, the computer controls the ASRS, the sorter, and any upstream, intermediate, or downstream material handling components to direct and transport the inventory item from the ASRS to its required destination downstream of the sorter (e.g. a packing station).

In one aspect, the material handling system includes an induct positioned between the ASRS and sorter and in transport communication with each. At least one RFID reader is positioned at or proximate the induct to read RFID tags of inventory items that are present at the induct. The computer system controls the induct to transfer an inventory item between the ASRS and the sorter. The computer may determine a location of an inventory item's RFID tag relative to the RFID reader at the induct to facilitate handling of the inventory item at the induct and downstream of the induct to ensure that the inventory item reaches its required destination.

In another aspect, the induct may be operable to dump all items out of an inventory receptacle (e.g. onto a conveyor surface of the induct) and to forward all of the dumped items from the induct to the sorter. The computer, utilizing information provided one or more of the RFID readers, directs the sorter to transport and transfer any required items to a required downstream process and to direct and transfer any non-required items back into circulation for future order fulfilment processes, such as back into the ASRS for storage until those items are required.

Accordingly, the RFID enabled verification system and method and the RFID enabled material handling system of the present invention enhance order picking functions and material handling operations. The verification system and method are particularly well suited for order fulfilment and warehouse facilities in which multiple different SKUs are stored in a single inventory tote such that items in the tote may not be readily visually distinguishable by the picking operator. The verification system and method provide a verification and feedback system without requiring additional verification steps to be taken by the order picker. The system is capable of providing immediate and accurate feedback to an order picker, preferably without the need for the order picker to perform any visual inspection. The verification system may be adapted for use in an RFID enabled material handling system in which individual items (or containers or receptacles) with RFID tags are directed through a facility as a function of their locations proximate RFID readers disposed throughout the facility. In such embodiments, the verification system monitors and directs the components of the facility to transport the item to its destination and the system verifies and validates that each individual item has indeed reached its required destination.

These and other objects, advantages, purposes and features of this invention will become apparent upon review of the following specification in conjunction with the drawings.

### BRIEF DESCRIPTION OF THE DRAWINGS

FIGS. 1A-1B are a diagram of a method for directing, verifying, and validating item level order fulfilment operations, in accordance with the present invention;

FIG. 2 is a perspective view of a verification system for an order fulfilment workstation, in accordance with the present invention;

FIG. 3 is a diagram of an aspect of the method of FIGS. 1A-1B;

FIG. 4 is a diagram of an aspect of the method of FIGS. 1A-1B;

FIG. 5 is a diagram of an aspect of the method of FIGS. 1A-1B;

FIG. 6 is a diagram of an aspect of the method of FIGS. 1A-1B;

FIG. 7 is a diagram of an aspect of the method of FIGS. 1A-1B; and

FIG. 8 is a plan view of a transportation system for an automated order fulfilment facility.

### DESCRIPTION OF THE PREFERRED EMBODIMENTS

Referring now to the drawings and the illustrative embodiments depicted therein, systems and methods are provided for directing, verifying, and validating item level picking and placing operations at an order fulfilment workstation and within a material handling facility (e.g. warehouse or order fulfilment facility). An order management system directs the pick operations at the workstation by directing the operator to select items from inventory receptacles or totes present at the workstation in order to fulfil orders requiring particular items present in the totes. The order management system includes an order database containing information including the inventory items in the order fulfilment facility or warehouse facility, pending orders to be fulfilled, and order sequences or pending work order priorities to be assigned to one or more order fulfilment workstations within the facility. The system and method utilize radio frequency identification (RFID), e.g. RFID tags with unique identifiers, on individual inventory items within an order fulfilment facility. The system and method are particularly beneficial for item level order picking operations in which inventory totes contain multiple items (i.e. stock keeping units (SKUs)), and in particular totes having multiple different or heterogeneous items or SKUs (e.g. items of different shapes, sizes, quantities, versions, editions, etc.) in which one or more of the items are slated for picking and one or more of the items are not slated for picking. The system and method guide the operator of the workstation (based on assigned work orders) to locate and acquire a particular item within the tote, to confirm or verify that the operator acquired the correct item, and to validate that the operator places or deposits the item within an assigned order container or another inventory receptacle. The system and method are adaptable for use with both human and robotic pick operators, as will be described in further detail below. Additionally, it is contemplated that the method of verifying an action performed on an item by determining that an RFID tag on the item has moved may be utilized to control order fulfilment systems (e.g. conveyors, sorters, inducts, etc.) to direct individual items (e.g. products, containers, receptacles, totes, etc.) throughout the order fulfilment facility. The verification system may be integrated at a fixed position within a picking workstation, may be integrated with a wearable device worn by an order picker (e.g. a glove, hat, glasses, etc.), coupled to a portion of a robotic picking arm, integrated into inventory totes and order containers, or may be adapted and integrated at other stages of the picking process and/or order fulfilment operations.

The system and method track or monitor the location and/or movement of individual items in or around a tote and provide feedback to operators (e.g. order pickers), such as directional feedback or confirmatory feedback. For example, the system and method may guide or direct the operator to the item(s) to be picked or retrieved from a tote that is present at the workstation. Such as by providing information or feedback to the order picker about the location of the item in the tote (e.g. whether the item is in the right quadrant, left half, and/or top, middle, or bottom layer of the tote). Providing location information to the order picker prior to them accessing the tote reduces the time and effort required to search through the tote, visually inspect the items, and possibly eliminate the need for the operator to empty out other unwanted items in order to access wanted items that are otherwise obscured or covered by unwanted items. Once an item is lifted, shifted, rotated, or removed from the tote, the system and method automatically verify and confirm that the item picked is the correct item required for the pending order being fulfilled. In this manner, the system can provide feedback to the operator that a picked item is either the correct item or incorrect item without the need for the operator to have a line of sight of the item in the tote or requiring the operator to verify that they have selected the correct item after removing it from the tote. The system and method may also verify that if an operator selects an incorrect item, that they then subsequently replace the incorrect item before moving to retrieve the correct item. The order management system directs the operator to transfer the selected item from the inventory tote to an assigned order container (e.g. a shipping carton) or to a different inventory tote and the method automatically confirms the placement of the item in the proper order container or tote.

RFID tags affixed to each inventory item provide information storage and short-range transmitters for the items, and in this manner, unique RFID identifiers can be assigned to unique inventory items or SKUs. The RFID tag enables an RFID reader and the order management system to match information from the RFID tag of the item against an inventory SKU database to determine the SKU of the item scanned. The SKU can then be compared against the order database. It will be appreciated that one or more of various types and forms of RFID tags or RFID readers may be utilized with the system and method. Some examples of RFID tag types include ultra-high-frequency (UHF) RFID tags, high-frequency (HF) RFID tags, near field communication (NFC) RFID tags, and low-frequency (LF) RFID tags. While RFID tags are a preferred information storage unit for the system and method due to their inherent portability, inconspicuousness, and their ability to remain with the item after it has left the facility (such that it may return to the facility with the RFID tag intact, potentially facilitating efficient return processing), it will be appreciated that other acceptable information storage units may be utilized for the system and method within the facility, such as real-time location systems (RTLS) (e.g. ultra-wide band RTLS, Wi-Fi RTLS, or infrared RTLS). Alternatively or in addition to RFID tag location functionality, the system may be combined with other verification methods, such as weight monitoring of the tote, inspecting the tote with machine vision, or other known methods, to potentially improve the accuracy of the system and method.

The order management system includes a computer in communication with the workstation(s) and the RFID reader. The computer is capable of processing the information stored on the RFID tags (as communicated from the RFID reader to the computer) to identity the items in the tote present at the workstation. Accordingly, the computer is capable of determining a relative location of an item in the tote, identifying changes in the location (movement) of items in the tote relative to other items in the tote or relative to the tote itself or the workstation, determining whether an item has been picked or removed from the tote, and determining whether an item has been placed or disposed in a desired location or container (e.g. an order container). The computer of the order management system is programed with computer code, and may comprise one or more processors as well as hardware and software, including for performing the operations discussed herein.

An acquisition support system is provided for directing the operator to pick the correct item from the inventory tote. The acquisition support system utilizes the RFID tags on each inventory item and the RFID scanner of the workstation to indicate to an operator the identity of a required item and its location in three-dimensional space within a tote, and is therefore capable of providing guidance or feedback to the operator as to where to locate and pick the required item. A verification support system is provided for identifying which item an operator picks from the inventory tote and is capable of matching the identity and location of the picked item with a database of the order management system to determine whether the correct item was selected by the operator. A disposition or validation support system is provided for confirming whether the operator has placed or disposed the required item in a proper location (e.g. order container or another inventory tote) and the validation support system is capable of providing information or feedback to the order picker as to where to direct the placement of the item in the correct location.

While the verification system and method are particularly well suited for human operated goods-to-person (GTP) pick workstations, the system and method are also well suited for use with robotic picking operators at goods-to-robot (GTR) pick workstations. By determining the location of the wanted item within the tote by locating its RFID tag, the robot operator knows ahead of time where the wanted item is in 3D space within the tote. Having this information without the need of image capture devices, the robotic picker may be able to reach into the tote, move unwanted items aside, and retrieve the wanted item without having to wholly remove each unwanted item that is obstructing the wanted item. The robotic picker may include a gripping element or gripper for engaging and retrieving the items from the tote. The gripper may include a RFID reader incorporated thereon which may provide feedback to the robotic picker to direct the gripper of the robotic picker as it approaches the wanted item. The RFID reader may be utilized to provide confirmation that the gripper has approached the correct item and engaged that item, such as by verifying that the gripper is sufficiently close to the RFID tag of the wanted item, thereby verifying that the correct item has been retrieved by the robotic picker.

Optionally, the system and method may forgo determining movement of an item to determine if it had been picked or not, but instead includes a proximity detection device along with a grip detection device that are both disposed in a wearable device (e.g. a glove worn on the operator's hand). The glove with proximity and grip detection is capable of determining proximity of the operator's hand to the item and determining whether the operator is gripping, or sufficiently closed onto, an item or not. As such, the system is capable of determining whether the operator has picked and/or released the correct item. Some examples of proximity detection devices include induction proximity sensors, photoelectric proximity sensors, electromagnetic proximity sensors (e.g. infrared sensors), and the like. Some examples of grip detection devices include a glove or end effector with multiple resistive sensors enabled and adapted to recognize when an operator is gripping onto an item, i.e. their grip is closed onto an item, as opposed to when the operators grip is open.

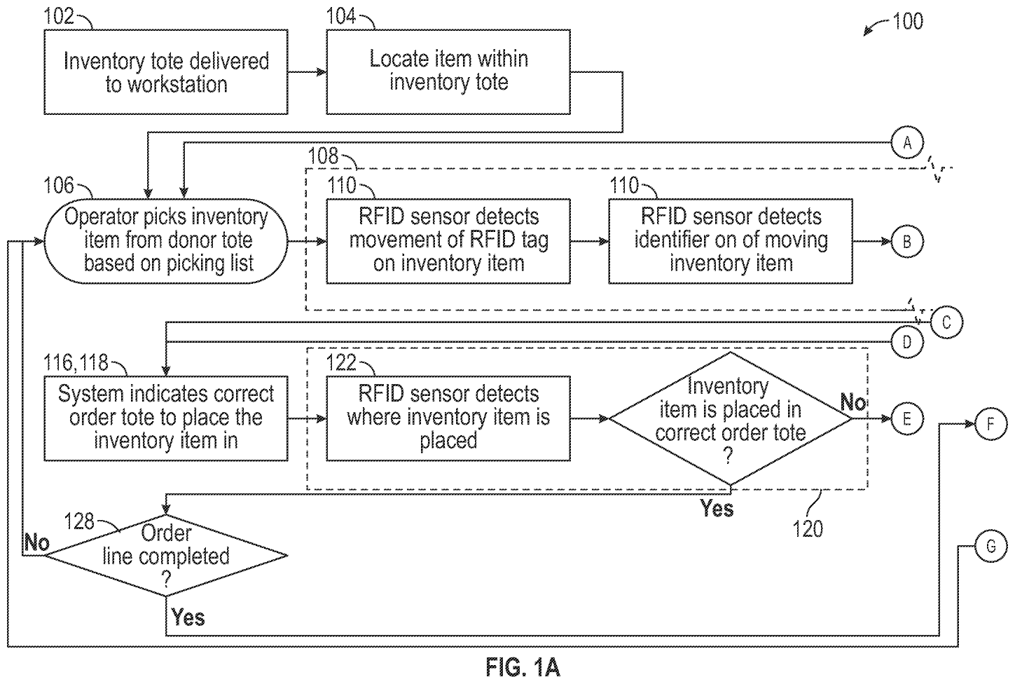

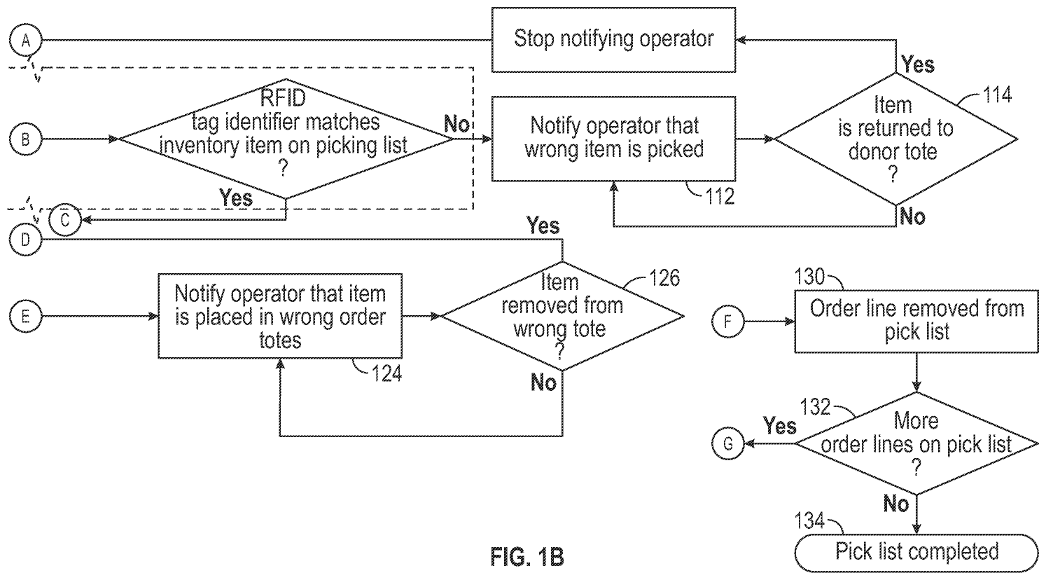

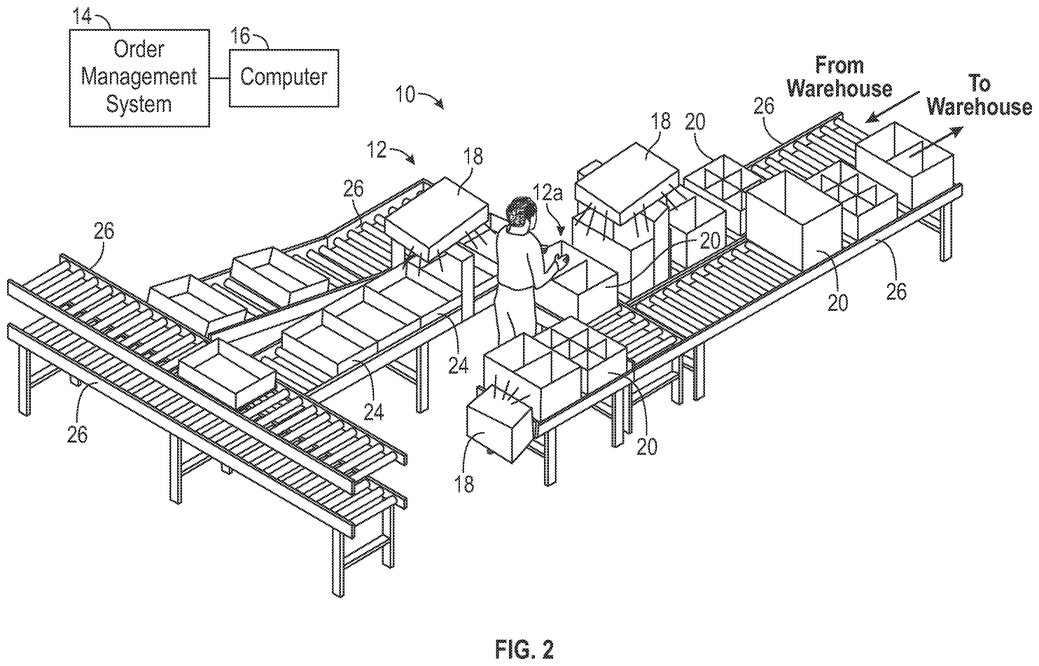

Referring to the illustrative embodiment of FIGS. 1A-1B, a method of item level order fulfilment 100 utilizing a verification system 10 (FIG. 2) includes transporting 102 an inventory receptacle 20 containing a plurality of different or heterogeneous inventory items or SKUs to an order fulfilment workstation 12. At least some of the inventory items in the inventory receptacle 20 include a radio frequency identification (RFID) tag affixed to the respective item. Preferably, all of the inventory items in the inventory receptacle 20 include an RFID tag. Each RFID tag includes stored information including an RFID identifier, and optionally, information about the item to which the tag is affixed. Each unique RFID identifier is assigned to only one particular type of inventory item. In this manner, any identical SKUs present in the receptacle have the same unique RFID identifier as one another, but that RFID identifier is not the same as the RFID identifier of any other dissimilar SKU. Alternatively, it will also be appreciated that the RFID tag of each individual item may have a unique RFID identifier, regardless of whether one or more individual item is identical or shares a SKU with another item.

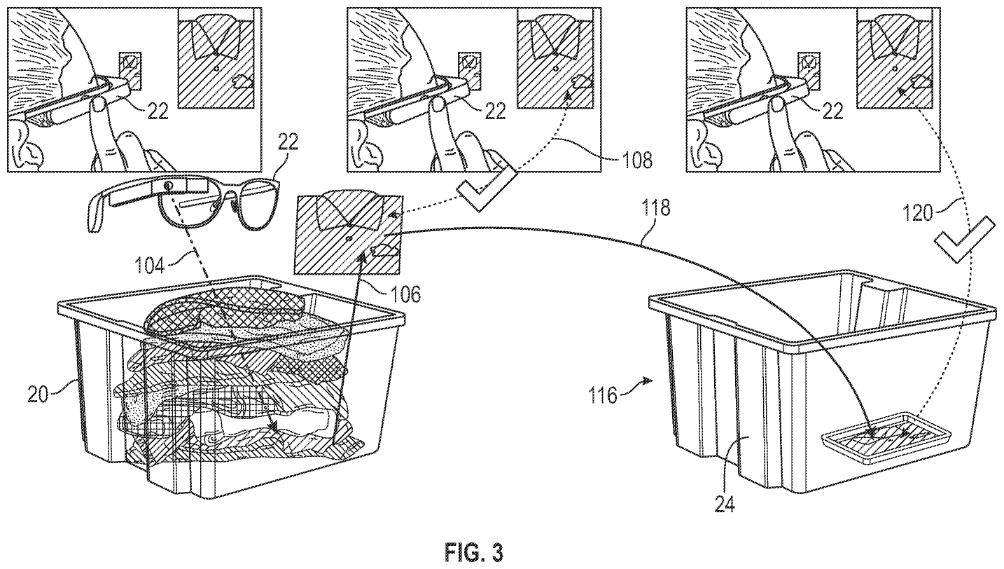

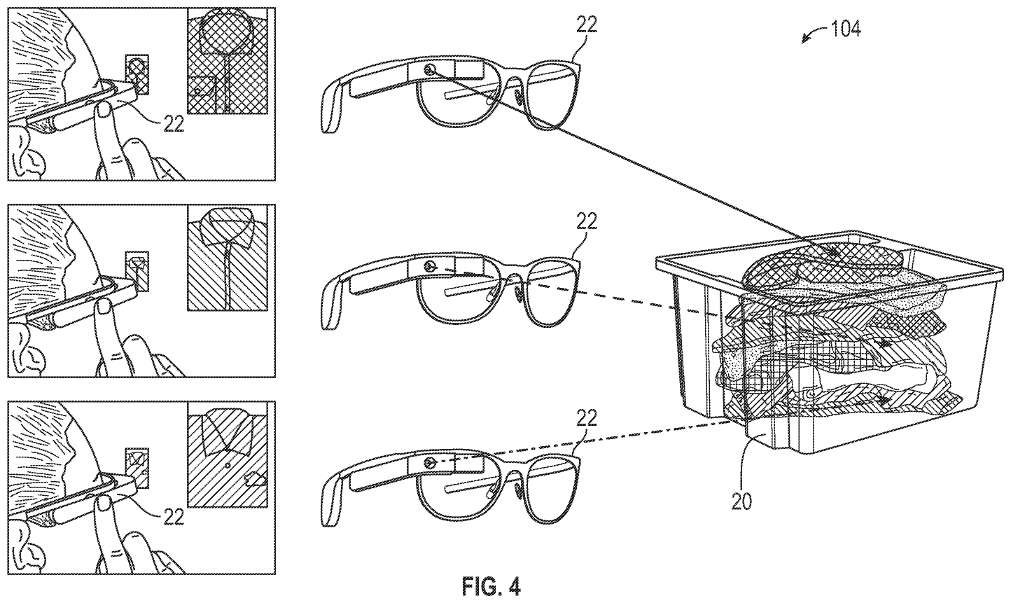

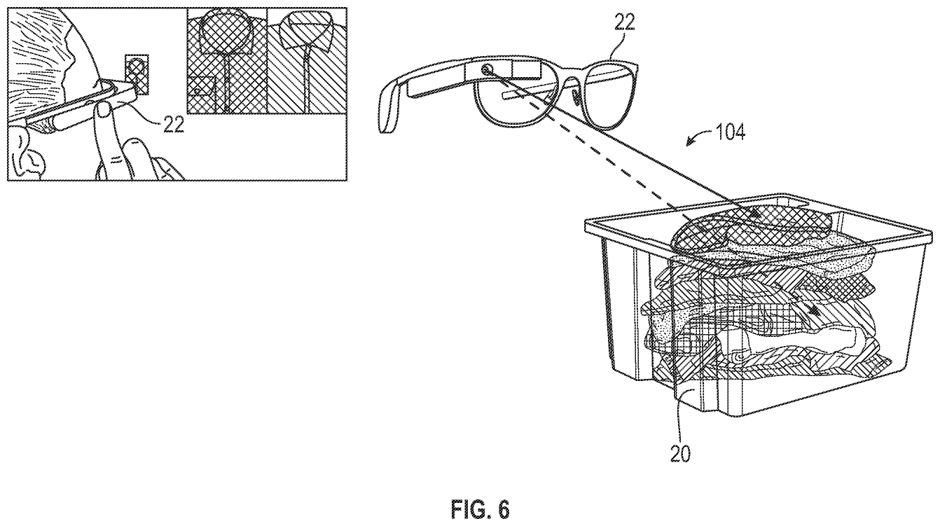

The method includes locating 104, within the inventory receptacle 20, an item required for an order and an operator (either human or robot) retrieving 106 the required item from the inventory receptacle 20 (FIGS. 1A-1B and 3-7). Locating 104 the required item within the receptacle may include detecting the RFID tag of the required item utilizing the RFID reader 18 and determining with the computer 16 the relative position of that RFID tag relative to either the workstation 12, the inventory receptacle 20, or other RFID tags on other items in the inventory tote 20. The method 100 may include directing the operator to the required item within the inventory receptacle 20 with an indicator, such as a visual/visible, audible, or physical feedback or cue, such as directing an operator to a target direction of an item with the indicator, such as by illuminating a laser light (e.g. pointing the light to the item), providing a virtual representation of the item with a heads-up display, providing a target direction with a spatial sonification device, providing a target direction with a wearable device having a haptic feedback function, lighting a representative position on the outside of the tote to indicate the relative position of the wanted item inside the tote, and/or illustrating the position of the item on a picking station screen, for example (FIGS. 3, 4, and 6). As an example, a human operator may wear a pair of glasses 22 with a heads-up display (HUD) and the display may signal different colors for items at different elevations (e.g. green (indicated in FIG. 4 with a straight line at 104) for items near the top of the tote, yellow (indicated in FIG. 4 with a dashed line at 104) for items near the middle, and red (indicated in FIG. 4 with a dot-dash line at 104) for items near the bottom). The system 10 may be operable to recognize and indicate, via the HUD, positions of the multiple items at one time, such as when two or more items are needed from a present inventory tote 20 (FIG. 4). For robotic operators, the computer directs the movement of the robot to the location of the required item using electronic control information (e.g. spatial coordinates, etc.). Directing the operator with visual/visible, audible, physical, or electronic feedback may reduce the time necessary for an operator to locate the required item and thereby improve the operator's efficiency and accuracy. Optionally, augmented reality or other visual indicators may provide the operator with visual information indicating where his hand/finger is located relative to where the item is located in the tote (i.e. how close to their hand is to the targeted item) during the item retrieval operation.

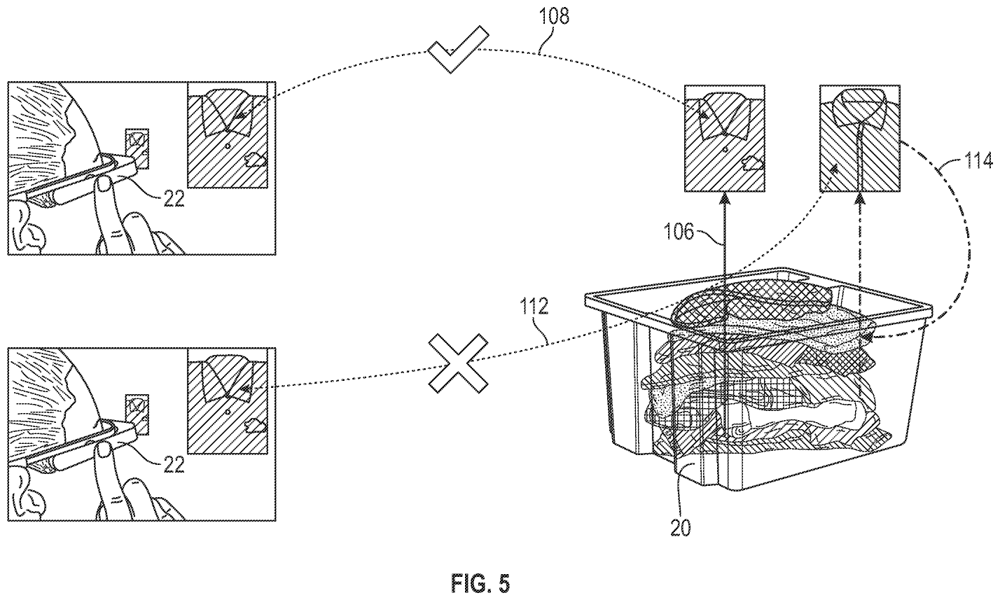

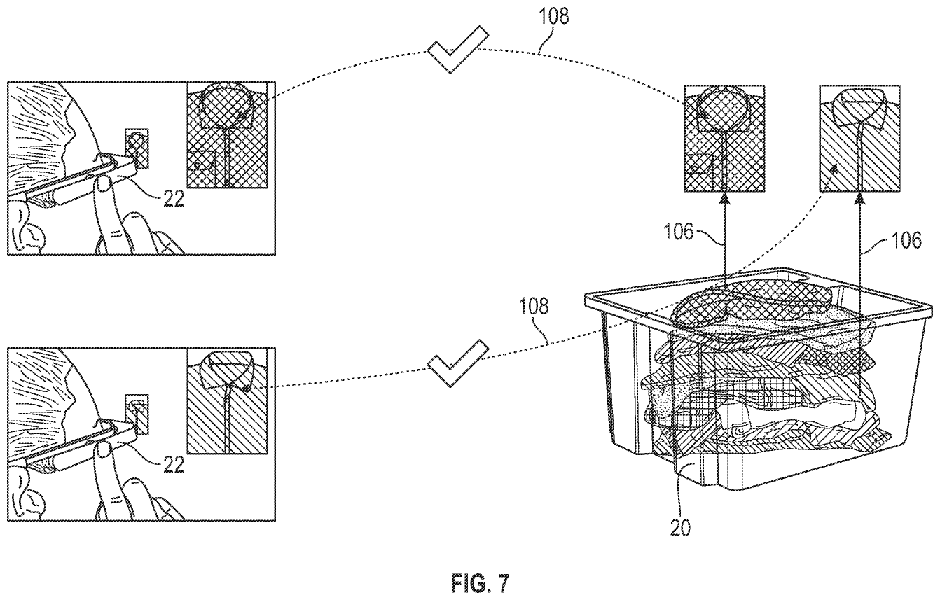

Once the operator has retrieved or moved the required item, the method 100 includes verifying 108 that the operator has correctly selected the required item by recognizing 110 a movement of the RFID tag affixed to that item with an RFID reader or sensor positioned at the workstation 12. The RFID reader is in communication with a computer 16 of an order management system 14 and the computer is configured to receive information from the RFID reader 18 and determine, based on the received information, if the RFID tag has moved in 3D space relative to either the workstation 12, the inventory receptacle 20 containing the inventory item (which may include a unique RFID tag affixed to the receptacle), or an RFID tag of another item in the inventory tote 20. Recognizing 110 a movement of the RFID includes determining with the computer if there has been a change in a positional characteristic of the RFID tag, such as an elevation change, a horizontal translation, or a rotation, for example. The system 10 may recognize that an RFID tag of a particular item in a tote of mixed SKU items has moved a significant or sufficient distance (after its initial arrival at the picking station) to determine that the item has been selected by the operator. For example, the system may recognize that the RFID tag of an item has reached a certain elevation above other items in the inventory tote 20 or has disappeared from or moved out of the envelope of the inventory tote 20, and thus the system may conclude that the item associated with that RFID tag has been picked. The envelope of the tote 20 may be represented by the tote's perimeter dimensions and/or the storage volume/capacity of the tote. The verification 108 and recognizing 110 are performed automatically, as directed by the computer 16 and order management system 14, and thus does not require confirmation from an operator that the correct item has been picked. In instances where multiple items are required from the present inventory receptacle 20, the method 100 is capable of verifying 108 that each of the correct items have been picked by the operator (FIGS. 1A-1B and 7). The operator is corrected 112 if they have selected a wrong item, such as with haptic feedback via a wearable device worn on the operator's person, for example, and the operator returns or replaces 114 the item into the inventory tote 20 (FIGS. 1A-1B and 5).

If it is verified that the item is accurately selected from the inventory tote 20 at 108, the method 100 includes assigning 116 an order container or tote 24 at the workstation 12 in which to place the retrieved item into (FIGS. 1A-1B and 3). The operator transfers 118 the selected item into the assigned order container 24. Similar to the locating step 104, the method 100 may include directing the operator to the required placement location within the workstation (e.g. an order container 24 or particular portion of the order container or another inventory tote 20) with a visual, audible, or physical feedback or cue, such as a laser light, a heads-up display, a spatial sonification device, a wearable device with a haptic feedback function, lighting a representative position on the workstation or outside of the tote to indicate the desired position of the wanted item, or illustrating the desired placement position on a picking station screen, for example. For robotic operators, the computer directs the movement of the robot operator to the placement location for the item.

The placement or disposition of the item into the order container 24 is validated 120 by determining or recognizing 122 that the location of the RFID tag is within an envelope of the assigned order container (and possibly to a particular quadrant or location within the container) to confirm that the required item is correctly disposed in the assigned order container 24 (FIGS. 1A-1B and 3). Recognizing or determining 122 that the RFID has moved to within the envelope of the order container (or a more precise position within the container) includes determining with the computer if a positional characteristic of the RFID tag, such as its elevation, horizontal location, or orientation, are within the envelope of the order container. For example, the required accuracy (i.e. tolerance) of the elevation of the item's RFID tag as compared to the pre-determined or instantaneously determined height of the order container may be pre-defined (e.g. at least 5 millimeters below the upper edge of the container), such that if the RFID tag is determined to be below the height of the order container (i.e. meeting the required tolerance), the item is determined by the computer to have been properly placed in the order container. In instances where the order container 24 includes an RFID tag, the validation 120 may be determined 122 as a function of the proximity of the item's RFID tag to the RFID tag of the order container.

Similar to the incorrect pick and correction scenario of steps 112 and 114, the operator is corrected 124 if they have placed the item in the incorrect location or order tote 24, such as with haptic feedback via a wearable device worn on the operator's person, for example (FIGS. 1A-1B). The operator must subsequently remove 126 the item from the incorrect tote and the operator is re-directed at 116 and 118 to transfer the item into the correct order container (FIGS. 1A-1B). If it is determined at 122 that the item is correctly placed in the order container 24, the method determines 128 if the order for the assigned order container requires any additional items or order lines, and if so, the method locates 104 the additional item(s) in the inventory tote and steps 106-126 are repeated as necessary until the order is complete. If an order line is completed it is removed 130 from the order database or pick list. Steps 102-130 are repeated if necessary to fulfil 132 all order lines on the pick list, and once all order lines are complete the method determines that the order or pick list is completed at 134.

Validating 120 that the required item is disposed in the assigned order container may include determining a location of an RFID tag that is affixed to the assigned order container and comparing the position of the RFID tag of the required item relative to the envelope of the assigned order container. Preferably, the envelope dimensions of the assigned order container are associated with the RFID tag affixed to the assigned order container. However, it will be appreciated that the envelope dimensions may be determined by other acceptable methods, such as by capturing image data of the order container with an image capture device and the computer of the order management system determining the dimensions of the container utilizing the captured image data, for example. The order picking process is improved and made more efficient by accurately verifying whether the correct item has been picked and/or validating whether the picked item has been placed or disposed in the correct location, without requiring an additional operator process step (e.g. scanning the selected item or performing a visual confirmation) to be performed by the operator.

The verification system 10, as mentioned above, is provided for monitoring item level order fulfilment operations at an order fulfilment workstation 12 that is in communication with an order management system 14 (FIG. 2). The verification system 10 includes a computer 16 in communication with the order management system 14 and one or more radio frequency identification (RFID) readers or sensors 18 that are in communication with the computer (e.g. either wired or wireless communication). It will be appreciated that a single RFID reader may be sufficient to perform the desired verification of item level order fulfilment operations within a particular facility. Inventory items within the facility are fitted with RFID tags. While it is preferable that all of the inventory items include an RFID tag, it will be appreciated that this is not a requirement and only some of the inventory items may include RFID tags. The RFID readers or sensors 18 read/recognize RFID tags that are in proximity of the reader (i.e. RFID tags on items that are present at the workstation) and communicate information associated with the RFID tags to the computer 16. The order management system 14 and computer 16 control the order fulfilment workstation 12 and may direct item level picking operations of an operator at the order fulfilment workstation 12, either human or robotic operators. The RFID reader 18 is positioned at a remote location relative to the picking area 12a of the workstation 12 (FIG. 2). The computer 16 is adapted to determine a location of inventory items' RFID tags relative to either the workstation 12, a receptacle or inventory tote 20 containing the inventory item, or relative to RFID tags of other inventory items in the inventory tote 20. The computer 16 verifies 108 that an operator at the workstation 12 has correctly chosen a particular one of a plurality of inventory items that are present at the workstation 12 by recognizing 110 a movement of the RFID tag of the correct inventory item (FIGS. 1A-1B and 2).

The verification system 10 includes a pick directing device, such as a wearable in the form of glasses 22 (FIGS. 3-7) that provide a laser light or heads-up display, for directing or guiding the operator to the location of a particular inventory item or items at the workstation 12. The glasses 22 are preferably dynamic such that as the operator moves their head or body, the location indicator automatically adjusts to continue to show the location of the required item. It will be appreciated that other types of pick directing devices may be used to guide or direct the operator, such as a spatial sonification device, a wearable device with a haptic feedback function, a smart lighting system operable for lighting a representative position on the outside of the tote to indicate the relative position of the wanted item inside the tote, or illustrating the position on a picking station screen, for example. Robotic operators may be controlled by the computer to direct their picking operations.

The computer 16 may be adapted to direct an operator to place the retrieved item in a particular order container 24 and to validate that the operator has placed the item in the correct order container 24 by determining that the location of the item's RFID tag is within an envelope of the correct order container 24. The pick directing device (e.g. glasses 22, laser light, heads-up display, spatial sonification device, wearable device with a haptic feedback function, smart lighting system, picking station screen, or electronic controller) may be adapted to direct the operator to a particular location where the retrieved item needs to be placed. It will be appreciated that the retrieved item may require placement onto a conveyer 26, into an order container 24 as described above, or into another inventory tote 20, whichever is necessary for processing the retrieved item.

The verification system 10 may be operable to determine whether the item is placed at a particular portion of the placement location. For example, for an order container 24 having multiple compartments, the RFID reader 18 and computer 16 may be capable of locating the RFID tag of the placed item and determining that it is placed in the correct quadrant or compartment of the order container 24. The order container 24 may include an RFID tag affixed to one or more portions thereof and the RFID reader 18 can communicate to the computer 16 the position of the RFID tag of the order container 24. As such, the computer 16 may compare the position of the RFID tag of an item placed in the order container 24 with the position of the RFID tag of the order container 24 to determine if the item has been placed in the correct portion of the order container 24. Preferably, the envelope (i.e. perimeter dimensions) of the order container 24 is associated with the container's RFID tag and the computer 16 can access the envelope dimensions with information provided by the RFID reader 18. It will be appreciated that the system 10 may include image capture devices in communication with the computer 16 to gather image data of an order container 24 present at the workstation 12. The image capture devices enable the computer 16 to determine the envelope of the present order container 24 and then determine and validate whether the RFID tag of a placed item is within the envelope of the order container 24.

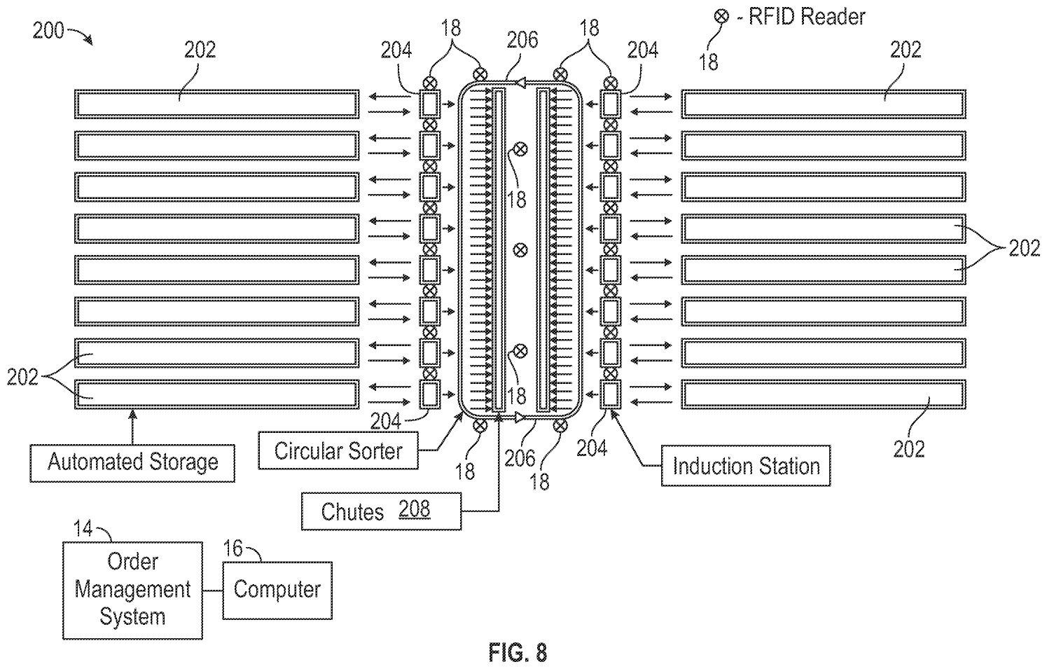

Referring to the illustrative embodiment of FIG. 8, an RFID enabled material handling system 200 is provided for an order fulfilment or warehouse facility. The handling system 200 is provided for tracking and monitoring the movement of individual items within the facility. The system 200 includes various or multiple RFID readers or sensors 18 distributed throughout the system 200 and positioned in proximity to various or multiple components of the system 200, including automated storage and retrieval systems (ASRS) 202, induction stations or inducts 204, and along the path of an automated unit sorter, such as in the form of a circular sorter 206 as shown in FIG. 8, or any other suitable sortation system. The individual items handled by the system 200 each have an RFID tag affixed thereon. Preferably each individual item includes an RFID tag, however, it will be appreciated that the system 200 is also beneficial when only some of the items have RFID tags. The individual items are routed from an ASRS 202 to a corresponding induct 204 in an inventory tote 20. An RFID reader 18 at the induct 204 reads any RFID tags of items within the inventory tote 20 and sends that information to a computer 16. The computer 16 determines which items within the inventory tote 20 are required for an order or for transport to a different portion of the facility. The required items are inducted (i.e. transferred) to the sorter 206 which directs the individual items to the appropriate downstream process (e.g. conveyor, Gaylord, pouch, order container, etc.) via chutes 208. The RFID readers 18 proximate the path of the sorter 206 read and track the RFID tags of individual items as they traverse the sorter 206 and the readers 18 send the information to the computer 16. Utilizing the tracked location information of an item's RFID tag, the computer 16 directs the sorter 206 to divert the individual item to the appropriate chute 208. The system 200 and method 100 may utilize structural arrangements and functions (such as the sorter, induct, and chute arrangement and control, for example) is similar manner to those disclosed in commonly owned and assigned U.S. Provisional Patent App. Ser. No. 63/312,945, filed Feb. 23, 2022, by Dematic Corp. of Grand Rapids, Mich. and entitled OMNICHANNEL SORTATION SYSTEM, the disclosure of which is hereby incorporated herein by reference in its entirety.

The induct 204 may discharge individual items in various manners. For example, an operator (human or robot) at the induct 204 may select only required items from the inventory tote 20 and transfer each required item to the sorter 206, possibly in a similar manner to how items are located 104 and retrieved 106 for method 100 as described above and illustrated in FIGS. 1A-1B, for example. As another example, an operator at the induct 204 or an automated mechanical device may dump or otherwise empty the entire contents of the inventory tote 20 onto the induct 204 and the operator may select any required items and forward them to the sorter 206, which may be performed with the aid of the RFID readers 18 and the computer. In yet another example, the induct 204 may forward all of the dumped items to the sorter 206 and the computer 16, utilizing information gathered by the RFID readers 18 at the sorter 206, will direct any required items to appropriate chutes 208, and any unwanted items may be directed back to a recirculation system to be replaced back into an ASRS 202 for future orders processes. Alternatively, the induct 204 may be omitted or bypassed and the inventory tote 20 may be emptied or dumped directly onto the sorter 206 and the computer 16 and RFID readers 18 cooperate to direct the required items to appropriate chutes 208 and any unwanted items may be directed back to an ASRS 202. Accordingly, the RFID enabled handling system 200 utilizes RFID readers 18 and RFID tags on individual inventory items to direct the items to appropriate locations and processes within the facility and also verifies and validates that the required items are delivered to their appropriate location.

Thus, the verification system and method of the present invention enhance the order picking function within an order fulfilment facility in which multiple different SKUs are stored in a single inventory tote wherein items may not be readily visually distinguishable by the picking operator. The verification system and method provide a verification and feedback system that does not require additional verification steps to be taken by the order picker, and is capable of providing immediate and accurate feedback to an order picker, preferably without the need for the order picker to perform any visual inspection. The verification system may be adapted for use in an RFID enabled material handling system in which individual items with RFID tags are directed through a facility as a function of their locations proximate RFID readers disposed throughout the facility. The verification system is enabled to verify and validate that each individual item has reached its required destination.

Changes and modifications in the specifically described embodiments can be carried out without departing from the principles of the present invention which is intended to be limited only by the scope of the appended claims, as interpreted according to the principles of patent law including the doctrine of equivalents.

1. A method of item level order fulfilment, said method comprising:
transporting a receptacle comprising a plurality of different inventory items to an order fulfilment workstation, wherein at least some of the inventory items in the receptacle comprise a radio frequency identification (RFID) tag coupled thereto, each RFID tag having an RFID identifier, wherein each unique RFID identifier is assigned to a particular type of inventory item;
locating, within the receptacle, an item required for an order;
an operator retrieving the required item from the receptacle; and
verifying that the operator has selected the required item by recognizing a movement of the RFID tag coupled with that item with an RFID reader positioned at the workstation, wherein the RFID reader is in communication with a computer of an order management system and the computer is adapted for receiving information from the RFID reader and determining if the RFID tag has moved relative to at least one chosen from the workstation, the receptacle containing the inventory item, and an RFID tag of another item in the receptacle.

2. The method of claim 1, wherein said recognizing a movement of the item's RFID tag comprises recognizing a change in a positional characteristic of the item's RFID tag comprising at least one chosen from an elevation change, a horizontal translation, and a rotation.

3. The method of claim 1, wherein said locating the required item within the receptacle comprises detecting the RFID tag of the required item utilizing the RFID reader.

4. The method of claim 3, wherein the operator comprises a human operator and said locating the required item within the receptacle further comprises directing the operator to the required item within the receptacle with at least one chosen from a visible cue, an audible cue, and a physical cue.

5. The method of claim 4, wherein said directing the operator comprises at least one chosen from illuminating the item with a laser light, providing a virtual representation of the location of the item with a heads-up display, providing a target direction of the item with a spatial sonification device, and providing a target direction with a wearable device comprising haptic feedback.

6. The method of claim 3, wherein the operator comprises a robot operator in communication with the computer, and said locating the required item within the receptacle further comprises directing the operator to the required item within the receptacle with electronic control information from the computer.

7. The method of claim 1, wherein the operator comprises a proximity detection device and a grip detection device affixed thereon, and wherein said locating the required item within the receptacle comprises determining that the proximity detection device is sufficiently close to the required item and that the grip detection device has sufficiently closed to grip the item.

8. The method of claim 1, further comprising transferring the required item from the receptacle to an assigned order container and validating that the required item is disposed in the assigned order container by determining that the location of the RFID tag is within an envelope of the assigned order container.

9. The method of claim 8, wherein said validating that the required item is disposed in the assigned order container comprises determining a location of an RFID tag coupled with the assigned order container and comparing the position of the required item relative to the envelope of the assigned order container, wherein the envelope dimensions of the assigned order container are associated with the RFID tag of the assigned order container.

10. A verification system for monitoring item level order fulfilment operations at an order fulfilment workstation that is in communication with an order management system, said verification system comprising:
a computer in communication with the order management system;
a radio frequency identification (RFID) reader in communication with said computer and configured to read an RFID tag coupled to an inventory item that is present at the workstation and to communicate information associated with that RFID tag to said computer;
said computer is operable to determine a location of the inventory item's RFID tag relative to at least one chosen from the workstation, a receptacle containing the inventory item, and an RFID tag of another inventory item in the inventory receptacle; and
said computer configured to verify that an operator at the workstation has chosen a particular, correct one of a plurality of inventory items that are present at the workstation by determining a movement of the RFID tag of that correct inventory item.

11. The verification system of claim 10, wherein said computer system is configured to control the order fulfilment workstation and to direct item level picking operations of an operator at the order fulfilment workstation.

12. The verification system of claim 11, wherein said operator comprises a human operator, and said verification system further comprising a pick directing device comprising at least one of a laser light, a heads-up display, a spatial sonification device, and an operator worn haptic feedback device, for directing the operator to the location of a particular one of the inventory items at the workstation.

13. The verification system of claim 11, wherein said operator comprises a robot operator and said verification system further comprising a pick directing device comprising an electronic controller in communication with said robot and controlled by said computer for directing the robot operator to the location of a particular one of the inventory items at the workstation.

14. The verification system of claim 11, wherein said computer is configured to direct an operator to place the item in a particular, correct order container and to validate that the operator has placed the item in the correct order container by determining that the location of the item's RFID tag is within an envelope of the correct order container.

15. The verification system of claim 11, wherein said RFID reader is configured to read an RFID tag coupled to an order container and wherein said computer is configured to direct an operator to place the item in a particular, correct order container and to validate that the operator has placed the item in the correct order container by determining that the location of the item's RFID tag is within an envelope of the correct order container, wherein the envelope of the order container is associated with the container's RFID tag.

16. The verification system of claim 11, wherein the order fulfilment workstation is disposed in a material handling system comprising an automated storage and retrieval system (ASRS), an automated sorter in transport communication with said ASRS, and a plurality of said RFID readers positioned proximate multiple portions of at least one chosen from said ASRS and said sorter, wherein said computer is configured to control said ASRS and said sorter to direct and transport an inventory item from said ASRS to a required destination downstream of said sorter, and said computer operable to determine a location of an inventory item's RFID tag relative to a respective one of said plurality of RFID readers positioned proximate said at least one chosen from said ASRS and said sorter.

17. The verification system of claim 16 wherein the material handling system further comprises an induct in transport communication between said ASRS and said sorter, and at least one of said plurality of RFID readers positioned proximate said induct, wherein said computer is configured to control said induct to transfer an inventory item between said ASRS and said sorter, said computer operable to determine a location of an inventory item's RFID tag relative to said RFID reader proximate said induct.

18. An RFID enabled material handling system for item level material handling operations, said material handling system comprising:
an order management system comprising a computer configured to control said material handling system;
an automated storage and retrieval system (ASRS);
an automated sorter in transport communication with said ASRS;
a plurality of radio frequency identification (RFID) readers positioned proximate multiple portions of at least one chosen from said ASRS and said sorter, each of said RFID reader in communication with said computer and configured to read an RFID tag coupled to an inventory item that is being handled by said material handling system and that is in sufficient proximity to the respective one of said RFID readers, each of said RFID readers configured to communicate information associated with a read RFID tag to said computer;
said computer operable to determine a location of the inventory item's RFID tag relative to said respective RFID reader; and
said computer controlling said ASRS and said sorter to direct and transport the inventory item from said ASRS to its required destination downstream of said sorter.

19. The material handling system of claim 18, further comprising an induct in transport communication between said ASRS and said sorter, and at least one of said plurality of RFID readers positioned proximate said induct, wherein said computer system is configured to control said induct to transfer an inventory item between said ASRS and said sorter, said computer operable to determine a location of an inventory item's RFID tag relative to said RFID reader proximate said induct.

20. The material handling system of claim 19, wherein said induct is operable to dump all items out of an inventory receptacle and to forward all of the dumped items to said sorter, wherein said computer, utilizing information provided by at least one of said plurality of RFID readers, is adapted to direct any required items to a required downstream process and to direct any non-required items back into said ASRS for future order fulfilment processes.

21. The material handling system of claim 18, wherein said material handling system further comprises:
an order fulfilment workstation that is in communication with said order management system, and
at least one of said plurality of RFID readers positioned proximate said workstation and configured to read an RFID tag coupled to an inventory item that is present at said workstation and to communicate information associated with that RFID tag to said computer;
wherein said computer is operable to determine a location of the inventory item's RFID tag relative to at least one chosen from said workstation, a receptacle containing the inventory item, and an RFID tag of another inventory item in the inventory receptacle.
